(19) United States
(12) Patent Application Publication
(10) Pub. No.: US 2015/0171990 A1
(43) Pub. Date: Jun. 18, 2015

(54) TRANSMISSION DEVICE, TRANSMISSION SYSTEM, AND TRANSMISSION METHOD

(71) Applicant: FUJITSU LIMITED, Kawasaki-shi (JP)

(72) Inventors: Tatsuya Kawasumi, Yokohama (JP); Toshihiro Togo, Kawasaki (JP); Kohei Ichimura, Fuchu (JP)

(73) Assignee: FUJITSU LIMITED, Kawasaki-shi (JP)

(21) Appl. No.: 14/559,146

(22) Filed: Dec. 3, 2014

(30) Foreign Application Priority Data
Dec. 13, 2013 (JP) 2013-258665

(51) Int. Cl. H04J 14/02

(52) U.S. Cl. CPC H04J 14/0271; H04J 14/0212

(57) ABSTRACT

A transmission device includes a receiver which receives a wavelength multiplex optical signal having a plurality of optical signals different in terms of wavelength multiplexed, a generator which generates notification signals, which notify another device of a failure in reception of the wavelength multiplex optical signal, for optical signals which are separated from the wavelength multiplex optical signal and which are transmitted to the other device, out of the plurality of optical signals, in accordance with frame types of the optical signals, and one or more transmitters which respectively convert the notification signals into wavelength optical signals having the same wavelengths as the optical signals out of the plurality of optical signals have and which respectively transmit the wavelength optical signals in place of the optical signals to the other device when the wavelength multiplex optical signal is not received in the receiver.

### CROSS-REFERENCE TO RELATED APPLICATION

This application is based upon and claims the benefit of priority of the prior Japanese Patent Application No. 2013-258665, filed on Dec. 13, 2013, the entire contents of which are incorporated herein by reference.

### FIELD

The embodiments discussed herein are related to a transmission device, a transmission system, and a transmission method.

### BACKGROUND

With increase in demand for communication, optical networks that make use of wavelength division multiplexing (WDM) have become widespread. The wavelength division multiplexing is a technique in which a plurality of optical signals different in terms of wavelength are multiplexed and transmitted. In the wavelength division multiplexing, optical signals with transmission rate of 40 (Gbps) of 88 waves may be multiplexed and transmitted as wavelength multiplex optical signals (which will be expressed below as “multiplex optical signals”), for instance.

As a transmission device that makes use of the WDM technique, an optical branching insertion device that is called a reconfigurable optical add-drop multiplexer (ROADM) device or the like has been known. The ROADM device has transmitter-receivers, which are called transponders or the like, for optical signals.

The ROADM device multiplexes optical signals with given wavelengths inputted from the transponders and transmits the optical signals to another node, while separating optical signals with given wavelengths from a multiplex optical signal received from another node and outputting the separated optical signals to the transponders. That is, the ROADM device carries out insertion and termination of optical signals with given wavelengths.

Upon detection of occurrence of a failure, the ROADM device outputs an alarm. Once the ROADM device detects that the ROADM device receives no multiplex optical signal, for instance, the ROADM device outputs an alarm that gives notice of WDM line failure.

As for detection of the alarm, for instance, patent literature 1 discloses detection of all of information “1” in received PCM signals and bidirectional transmission of alarm indication signals (AIS) to all devices provided on lower orders. Such a technique is disclosed in Japanese Laid-open Patent Publication No. 5-30075, for instance.

### SUMMARY

According to an aspect of the invention, a transmission device includes a receiver which receives a wavelength multiplex optical signal having a plurality of optical signals different in terms of wavelength multiplexed, a generator which generates notification signals, which notify another device of a failure in reception of the wavelength multiplex optical signal, for optical signals which are separated from the wavelength multiplex optical signal and which are transmitted to the other device, out of the plurality of optical signals, in accordance with frame types of the optical signals, and one or more transmitters which respectively convert the notification signals into wavelength optical signals having the same wavelengths as the optical signals out of the plurality of optical signals have and which respectively transmit the wavelength optical signals in place of the optical signals to the other device when the wavelength multiplex optical signal is not received in the receiver.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a structure chart illustrating a functional configuration of a transmission device according to a first comparative example;

FIG. 2 is a structure chart illustrating functional configurations of transmission devices according to a second comparative example;

FIG. 3 is a structure chart illustrating functional configurations of transmission devices according to a third comparative example;

FIG. 4 is a structure chart illustrating functional configurations of transmission devices according to a first embodiment;

FIG. 5 is a structure chart illustrating a configuration of an OTU frame;

FIG. 6 is a structure chart illustrating configurations of overheads of the OTU frame;

FIG. 7 is a table representing an example of frame information;

FIG. 8 is a flow chart illustrating processing in the transmission device according to the first embodiment;

FIG. 9 is a structure chart illustrating functional configurations of transmission devices according to a second embodiment;

FIG. 10 is a flow chart illustrating processing in the transmission device according to the second embodiment;

FIG. 11 is a structure chart illustrating functional configurations of transmission devices according to a third embodiment; and

FIG. 12 is a flow chart illustrating processing in the transmission device according to the third embodiment.

### DESCRIPTION OF EMBODIMENTS

In case where no multiplex optical signal is received, it is impossible for the transponders to receive optical signals that are to be made to demultiplex and thus an optical signal failure alarm that gives notice that it is impossible to receive the optical signals is outputted. Thus the ROADM device outputs the alarms of two different types, that is, the WDM line failure alarm and the optical signal failure alarm. In order to easily identify factors of a failure, however, it is desirable for one alarm to be detected for one factor of the failure.

In network management, a problem is therefore caused in that it is difficult to identify whether factors of an alarm arise from a receiver unit (such as an optical amplifier) for multiplex optical signal or from the transponders. When it becomes impossible for the ROADM device to receive multiplex optical signal, therefore, the ROADM device forbids output of the optical signal failure alarm in the transponders and thereby outputs only the WDM line failure alarm, for instance.

On condition that the transponders are configured as separate devices independent of a main unit of the ROADM device (“alien wavelength” configuration), for instance, however, it is impossible to carry out such processing for forbidding the alarm output as described above. In the “alien wavelength” configuration, accordingly, it is impossible to curb the output of the alarms of the two types and it is difficult to identify factors of an alarm.

### First Comparative Example

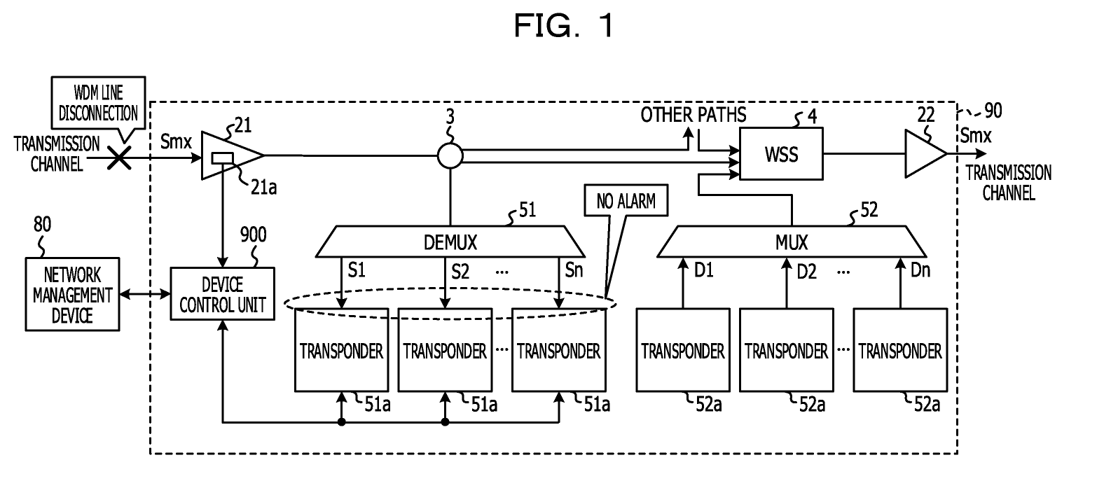

FIG. 1 is a structure chart illustrating a functional configuration of a transmission device according to a first comparative example. A transmission device 90, which is a ROADM device, for instance, makes optical signals demultiplex from a multiplex optical signal Smx inputted from a transmission device of an adjacent node through a transmission channel (optical fiber) and inserts optical signals into the multiplex optical signal Smx. The multiplex optical signal Smx is a signal in which optical signals different in terms of wavelength are multiplexed and includes optical signals of 88 waves at maximum, for instance. A network management device 80 monitors and controls the transmission device 90.

The transmission device 90 includes a device control unit 900, an input-side amplifier 21, an output-side amplifier 22, an optical splitter 3, a wavelength selective switch (WSS) 4, a separator unit 51, a multiplexer unit 52, and a plurality of transponders 51a, 52a. The configuration is provided for every path of the transmission device 90 (every transmission channel between the transmission device 90 and adjacent nodes).

The input-side amplifier 21 receives the multiplex optical signal Smx inputted from the transmission device of the adjacent node, amplifies the multiplex optical signal Smx by erbium-doped fiber, for instance, and outputs the multiplex optical signal Smx to the optical splitter 3. The optical splitter 3, which is an optical splitter, for instance, makes the multiplex optical signal Smx sepalate to the wavelength selective switch 4, wavelength selective switches on other paths, and the separator unit 51.

The separator unit (DEMUX) 51, which is an arrayed waveguide grating (AWG), for instance, separates optical signals S1 through Sn, having wavelengths to be made to demultiplex, from the multiplex optical signal Smx and outputs the optical signals S1 through Sn to the plurality of transponders 51a that are to respectively receive the optical signals S1 through Sn. The multiplexer unit (MUX) 52, which is an AWG, for instance, multiplexes optical signals D1 through Dn inputted from the plurality of transponders 52a and outputs the optical signals to the wavelength selective switch 4.

The transponders 51a are receivers that receive the optical signals S1 through Sn from the separator unit 51. The transponders 52a are transmitters that transmit the optical signals D1 through Dn to the multiplexer unit 52. Though the transponders 51a, 52a are provided independently of each other in the example, the transponders may integrally be provided as transmitter-receivers that transmit and receive optical signals.

The wavelength selective switch 4 multiplexes optical signals with selected wavelengths out of wavelengths of optical signals included in the multiplex optical signal Smx inputted from the optical splitter 3, multiplex optical signal inputted from branch units on other paths, and the multiplex optical signals inputted from the multiplexer unit 52. The wavelength selective switch 4 outputs the multiplexed optical signals as a new multiplex optical signal Smx to the output-side amplifier 22. The output-side amplifier 22 amplifies the multiplex optical signal Smx, inputted from the wavelength selective switch 4, by erbium-doped fiber, for instance, and outputs the multiplex optical signal Smx to the transmission device of the adjacent node. The wavelengths selected in the wavelength selective switch 4 are determined by the device control unit 900, for instance.

The device control unit 900 includes processors such as central processing units (CPUs) and the like, for instance. The device control unit 900 communicates with the network management device 80 and controls the entire transmission device 90. The device control unit 900 determines the wavelengths for the wavelength selective switch 4 pursuant to instructions from the network management device 80, for instance.

The device control unit 900 collects alarms that are in the transmission device 90. For instance, the input-side amplifier 21 detects through an inner reception detection unit 21a that the multiplex optical signal Smx is not received and outputs the WDM line failure alarm to the device control unit 900 (refer to sign “x”). As an alarm factor in the WDM line failure, a failure in a transmission channel or a failure in the transmission device (transmitter) of the adjacent node may be pointed out, for instance. The reception detection unit 21a may be provided outside the input-side amplifier 21.

When the multiplex optical signal Smx is not received in the input-side amplifier 21, it is impossible for the transponders 51a to receive the optical signals S1 through Sn. Accordingly, the transponders 51a each detect the optical signal failure alarm that gives notice that it is impossible to receive the optical signals S1 through Sn. Alarm factors in the optical signal failure, however, which include a failure in the separator unit 51, for instance, are operationally different from alarm factors in the WDM line failure.

If the device control unit 900 outputs to the network management device 80 the alarms of the two different types, that is, the WDM line failure alarm and the optical signal failure alarm, it is difficult to identify the alarm factors. In order to easily identify factors of a failure, therefore, it is desirable for one alarm to be detected for one factor of the failure.

When notified of the WDM line failure alarm, the device control unit 900 forbids detection of the optical signal failure alarm in each transponder 51a (refer to “NO ALARM”). Thus only the WDM line failure alarm is outputted to the network management device 80, and identification of the alarm factors is thereby facilitated. Forbidding the detection of an alarm (or the output of an alarm) in such a manner is referred to as mask processing of alarm, or the like.

On condition that the transponders 51a are configured as separate devices independent of a main unit of the transmission device 90 (“alien wavelength” configuration), for instance, however, it is impossible for the device control unit 900 to control the transponders 51a and to carry out the mask processing of the alarm.

### Second Comparative Example

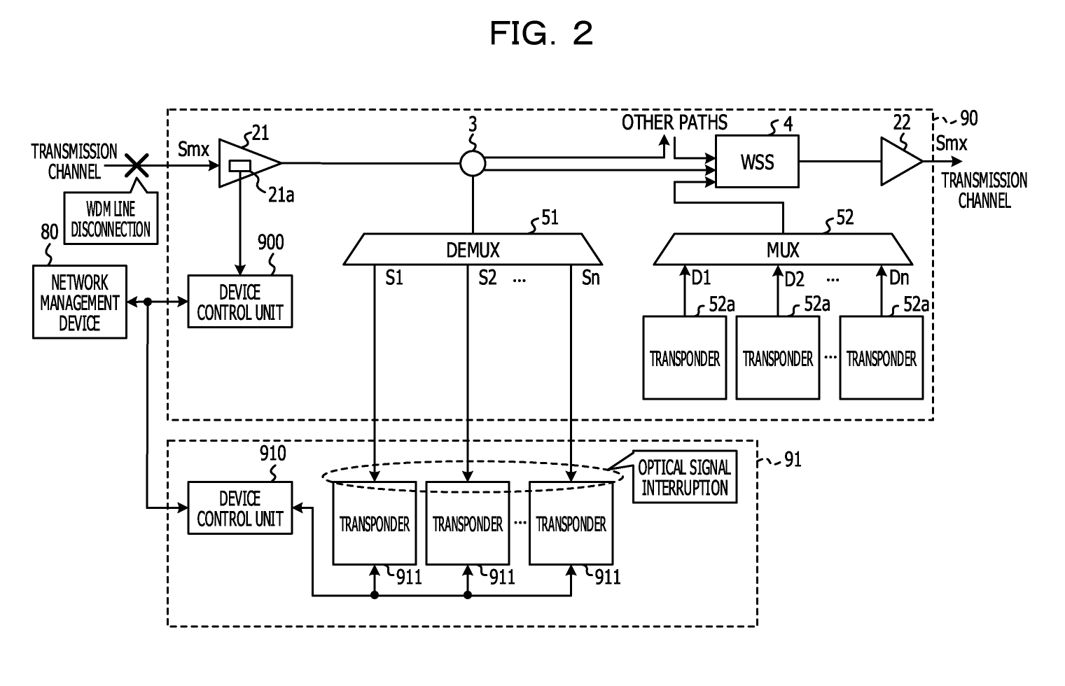

FIG. 2 is a structure chart illustrating functional configurations of transmission devices according to a second comparative example. In FIG. 2, configurations common to FIG. 1 are provided with the same reference characters, and description thereof is omitted.

In this example, transponders that receive the optical signals 51 through Sn to be made to demultiplex are provided in a receiving-side transmission device 91 independent of the transmission device 90. The receiving-side transmission device 91 includes the plurality of transponders 911 that respectively receive the optical signals 51 through Sn outputted from the separator unit 51 and a device control unit 910 that controls the entire transmission device 91.

When the WDM line failure alarm is detected in the input-side amplifier 21, in the example also, the optical signal failure alarm is detected in each transponder 911. The transponders 911 are controlled by the device control unit 910 different from the device control unit 900 that controls the input-side amplifier 21, and it is therefore impossible for the device control unit 900 to carry out the mask processing of the optical signal failure alarm.

In the “alien wavelength” configuration, accordingly, it is impossible to curb the output of the alarms of the two types and it is difficult to identify alarm factors. On condition that control information may be exchanged between the transmission devices 90 and 91, however, the mask processing of alarm may be carried out and thus such a problem is avoided.

### Third Comparative Example

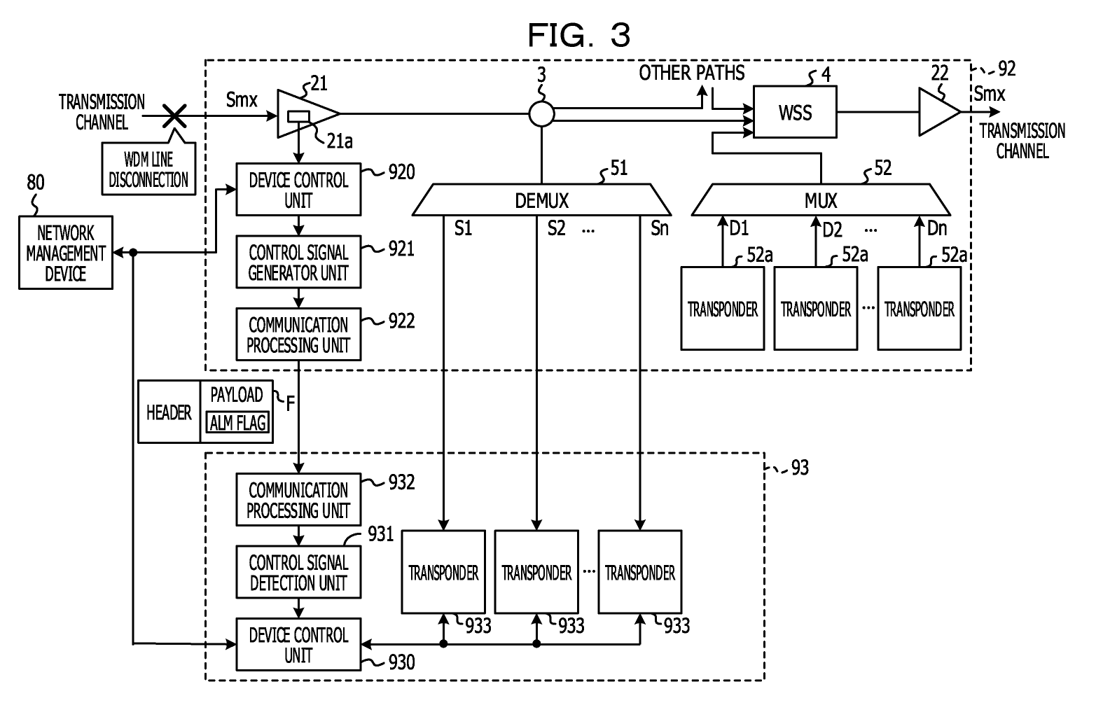

FIG. 3 is a structure chart illustrating functional configurations of transmission devices according to a third comparative example. In FIG. 3, configurations common to FIG. 1 are provided with the same reference characters, and description thereof is omitted.

A transmission device 92 includes a device control unit 920, the input-side amplifier 21, the output-side amplifier 22, the optical splitter 3, the wavelength selective switch (WSS) 4, the separator unit 51, the multiplexer unit 52, and the plurality of transponders 52a. The transmission device 92 further includes a control signal generator unit 921 and a communication processing unit 922.

A receiving-side transmission device 93 includes a device control unit 930, a control signal detection unit 931, a communication processing unit 932, and a plurality of transponders 933. The plurality of transponders 933 respectively receive the optical signals S1 through Sn outputted from the separator unit 51.

In the transmission device 92, the reception detection unit 21a detects that the multiplex optical signal Smx is not received and outputs the WDM line failure alarm to the device control unit 920 (refer to sign “x”). When receiving input of the WDM line failure alarm, the device control unit 920 instructs the control signal generator unit 921 to generate an alarm notification signal F. The control signal generator unit 921 transmits the alarm notification signal F through the communication processing unit 922 to the receiving-side transmission device 93.

The alarm notification signal F has a form of Ethernet® frame, for instance, and includes a header and a payload. The payload includes an ALM flag that gives notice of generation of the WDM line failure alarm. In the ALM flag with an area of 1 (Bit), for instance, having a value “1” (binary number) indicates that the WDM line failure alarm is generated and having a value “0” (binary number) indicates that the WDM line failure alarm is not generated.

In the receiving-side transmission device 93, the alarm notification signal F is inputted through the communication processing unit 932 to the control signal detection unit 931. When the ALM flag of the alarm notification signal F is “1”, the control signal detection unit 931 detects the WDM line failure alarm and gives notice to the device control unit 930.

When notified of the WDM line failure alarm, the device control unit 930 carries out the mask processing of the optical signal failure alarm in the plurality of transponders 933. For instance, the device control unit 930 forbids the plurality of transponders 933 to detect the optical signal failure alarm. Alternatively, the device control unit 930 forbids output of the optical signal failure alarm to the network management device 80.

When the wavelength multiplex optical signal Smx is not received in the transmission device 92, consequently, the network management device 80 is not notified of the optical signal failure alarm but notified of only the WDM line failure alarm. Thus the identification of the alarm factors is facilitated.

In a technique described above, however, use of a communication system between the transmission devices 92 and 93, that is, the communication processing units 922, 932 necessitates new communication lines for control and thus causes increase in costs. Besides, a demand for common control protocol between the transmission devices 92 and 93 makes it difficult to execute the technique, provided that the transmission devices 92, 93 are of different types.

### First Embodiment

Transmission devices according to embodiments generate notification signal that give notice of a failure in reception of a wavelength multiplexed optical signal in accordance with frame types of optical signals to be made to demultiplex, convert the notification signals into wavelength optical signals corresponding to the optical signals, transmit the wavelength optical signals in place of the optical signals to another device, and thereby easily identify alarm factors.

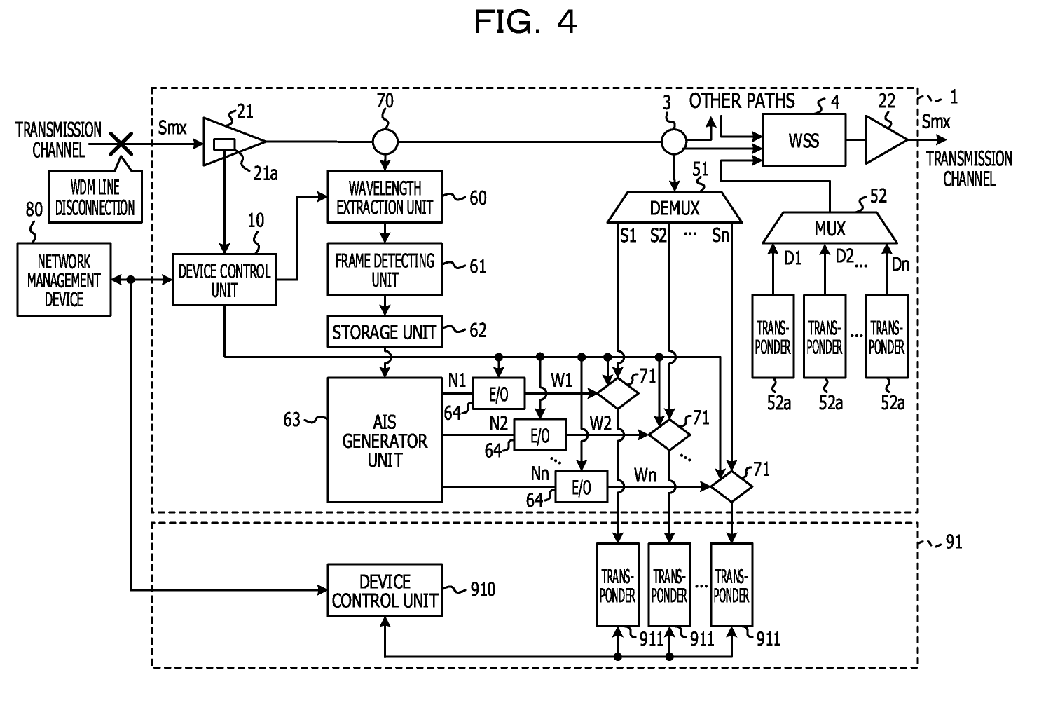

FIG. 4 is a structure chart illustrating functional configurations of transmission devices according to a first embodiment. In FIG. 4, configurations common to FIG. 2 are provided with the same reference characters, and description thereof is omitted.

A transmission device (first transmission device) 1 includes a device control unit 10, the input-side amplifier (receiver unit) 21, the output-side amplifier 22, optical splitters 70 and 3, the wavelength selective switch 4, the separator (demultiplexer) unit 51, the multiplexer unit 52, and the plurality of transponders 52a. The transmission device 1 further includes a wavelength extraction unit 60, a frame detection unit (detection unit) 61, a storage unit 62, an AIS generator unit (generator unit) 63, a plurality of electro-optic conversion units (transmitter units) 64, and a plurality of optical switches 71.

The receiving-side transmission device (second transmission device) 91 is connected to the transmission device 1 through optical fibers (transmission channels). The receiving-side transmission device (second transmission device) 91, together with the transmission device 1, forms a transmission system. The receiving-side transmission device 91 includes the plurality of transponders 911 that respectively receive the optical signals S1 through Sn outputted from the separator unit 51 and the device control unit 910 that controls the entire transmission device 91. As will be described later, the separator unit 51 and the plurality of transponders 911 are connected to each other through the plurality of optical switches 71.

The device control unit 10 includes processors such as CPUs and the like, for instance. The device control unit 10 communicates with the network management device 80 and controls the entire transmission device 1. The device control unit 10 determines wavelengths for the wavelength selective switch 4 pursuant to instructions from the network management device 80, for instance.

The optical splitter 70 causes branching of the multiplex optical signal Smx outputted from the input-side amplifier 21 and guides the signal to the wavelength extraction unit 60 and another optical splitter 3. The wavelength extraction unit 60, which is a wavelength filter, for instance, extracts from the multiplex optical signal Smx optical signals having wavelengths instructed from the device control unit 10 and outputs the extracted optical signals to the frame detection unit 61. The device control unit 10 selects the wavelengths of which the wavelength extraction unit 60 is to be instructed, from wavelengths of the optical signals that are to be made to demultiplex and switches the wavelengths for every unit time.

The frame detection unit 61 detects frame type of each of the optical signals S1 through Sn that are separated from the wavelength multiplex optical signal Smx and that are transmitted to the transponders 911, that is, the optical signals S1 through Sn that are to be made to demultiplex, among the plurality of optical signals included in the multiplex optical signal Smx. For instance, the frame detection unit 61 identifies the frame types by converting the optical signals S1 through Sn into electrical signals and checking patterns of the electrical signals with synchronization patterns included in header parts of frames of various types.

The frame detection unit 61 identifies types of external frames and types of internal frames as the frame types. The internal frames are frames of client signals. For instance, 100 gigabit-Ethernet® (GE), 40GE, OC768/STM256, 10G-fiber channel (FC), and the like may be enumerated as the internal frames. The external frames are frame structures in which the internal frames are contained. For instance, optical channel transport unit (OTU)-n frame (n is a natural number corresponding to transmission rate) may be pointed out as the external frames. OTU is provided for in the International Telecommunication Union Telecommunication Standardization Sector (ITU-T) Recommendation G.709.

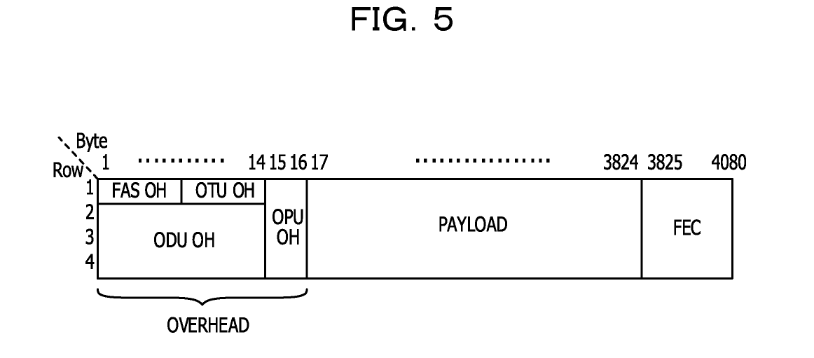

FIG. 5 is a structure chart illustrating a configuration of an OTU frame. In FIG. 5, “OH” represents overhead.

The overhead area includes frame alignment signal (FAS) overhead, OTU overhead, optical channel data unit (ODU) overhead, and optical channel payload unit (OPU) overhead. Each overhead includes various control information. A payload area is provided with one or more tributary slots (TS) (not depicted) that are logical channels and stores client signals for each TS.

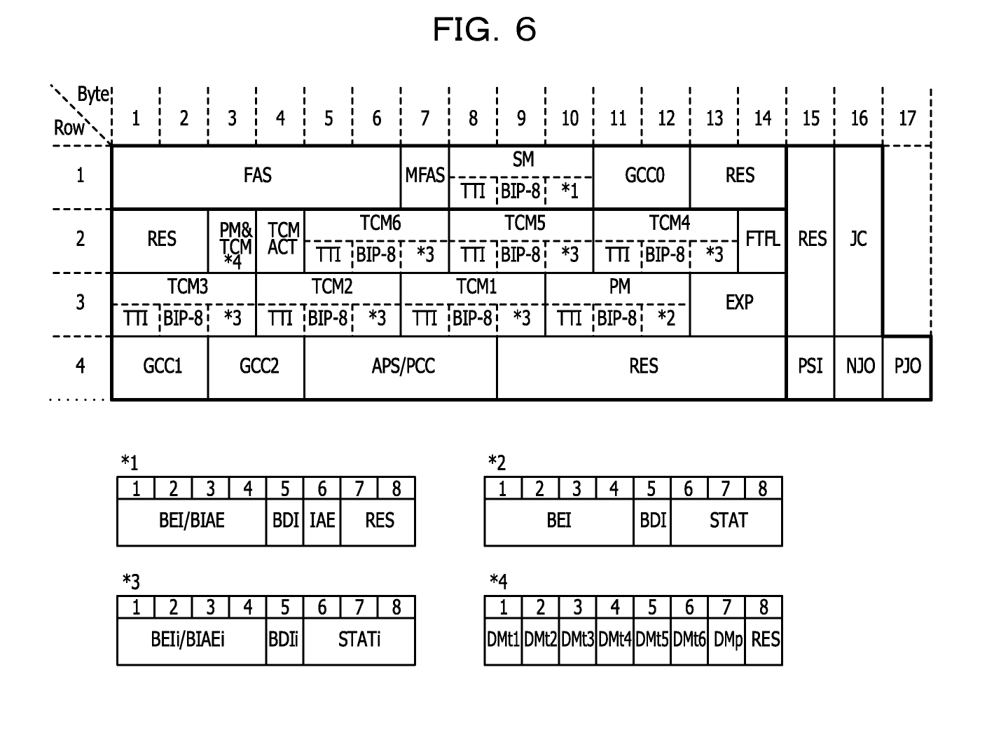

FIG. 6 is a structure chart illustrating configurations of overheads of the OTU frame. “ROW” and “BYTE” in FIG. 6 correspond to “ROW” and “BYTE” in FIG. 5, respectively. Contents of “*1” through “*4” in the frame are illustrated in “*1” through “*4” outside the frame, respectively.

The FAS overhead includes FAS and multi-frame alignment signal (MFAS) and is used for frame alignment processing in the transponders 911. Therefore, the FAS overhead has intrinsic pattern data indicating head of the OTU frame.

The OTU overhead provides monitoring function and includes section monitoring (SM), general communication channel (GCC) 0, and reserved for future international standardization (RES). The SM includes trail trace identifier (TTI) and bit interleaved parity level 8 (BIP-8). The SM further includes backward error indication (BEI)/backward incoming alignment error (BIAE), backward defect indication (BDI), incoming alignment error (IAE), and RES.

The ODU overhead includes RES, path monitoring (PM) & tandem connection monitoring (TCM), TCM activation/deactivation control channel (ACT), TCM1 through TCM6, and fault type & fault location reporting channel (FTFL). The ODU overhead further includes PM, experimental (EXP), GCC1, GCC2, and automatic protection switching coordination channel (APS)/protection communication channel (PCC). The PM & TCM includes delay measurement of TCM (DMt) 1 through 6, delay measurement of ODUk path (DMp), and RES.

TCM1 through TCM6 each include TTI, BIP-8, BEIi/BIAEi, BDIi, and status (STAT) i (i=1 through 6). The PM includes TTI, BIP-8, BEI, BDI, and STAT.

The OPU overhead includes payload structure identifier (PSI), justification control (JC), negative justification opportunity (NJO), positive justification opportunity (PJO), and RES. In generic mapping procedure (GMP) operation, RES is used as JC. Details of above parameters are provided for in ITU-T Recommendation G.709.

When detecting that the external frame is OTU-n, the frame detection unit 61 stores value of the TTI, together with the types of the external frame and the internal frame, in the storage unit 62. This is because an alarm is detected in the receiving-side transmission device 91 in case where the TTI values of AIS signals that will be described later and that are transmitted to the transponders 911 differ from expected values in the transponders 911.

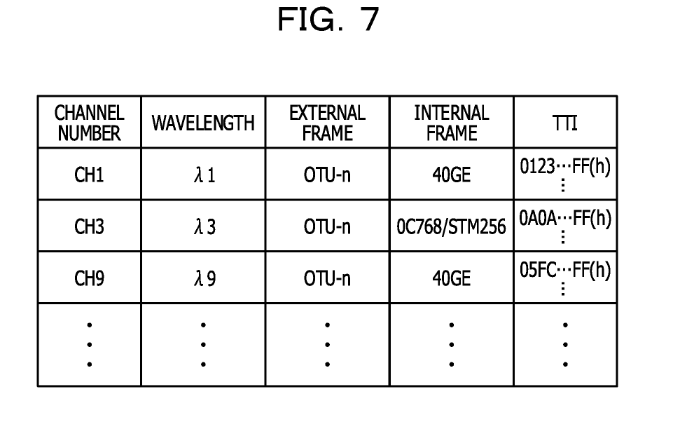

The storage unit 62, which is a memory, for instance, stores frame information that represents the frame types of the optical signals S1 through Sn. An example of the frame information is illustrated in FIG. 7.

“CHANNEL NUMBER” is a management number the network management device 80 allocates to each of the wavelengths of the optical signals multiplexed into the multiplex optical signal Smx. “WAVELENGTH” is a wavelength of an optical signal designated by “CHANNEL NUMBER”. “EXTERNAL FRAME” and “INTERNAL FRAME” respectively designate the frame types of the external frame and the internal frame of the optical signal. “TTI” designates the value of the TTI included in the OTU-n frame.

For instance, the optical signal of channel number CH1 has wavelength of λ1, the external frame of OTU-n, and the internal frame of 40GE. The wavelengths for the channel numbers are set in advance in the device control unit 10 by the network management device 80.

The device control unit 10 switches the wavelengths, of which the wavelength extraction unit 60 is to be instructed, for every unit time, and thus the frame detection unit 61 detects, in time-sharing manner, type of each frame of the optical signals S1 through Sn that are to be made to demultiplex. Accordingly, all the optical signals that are to be made to demultiplex are processed by the wavelength extraction unit 60 and the frame detection unit 61 that are common. In the embodiment, consequently, scale of hardware is decreased in comparison with examples in which the separate wavelength extraction unit 60 and the separate frame detection unit 61 are provided for each of optical signals that are to be made to demultiplex.

The AIS generator unit 63 generates notification signals (AIS signals) N1 through Nn that notify the transponders 911 of a failure in reception of the multiplex optical signal Smx, for the optical signals S1 through Sn that are separated from the multiplex optical signal Smx and that are transmitted to the transponders 911, in accordance with the frame types of the optical signals. That is, the AIS generator unit 63 generates the notification signals N1 through Nn, for the optical signals S1 through Sn that are to be made to demultiplex, in accordance with the frame types the frame detection unit 61 detects.

The AIS generator unit 63 reads out the frame information from the storage unit 62 and generates the notification signals N1 through Nn corresponding to the external frames and the internal frames the frame information designates. For instance, the notification signal N1 is generated in accordance with the frame types of the optical signal S1, and the notification signal N2 is generated in accordance with the frame types of the optical signal S2. Forms of the notification signals N1 through Nn are defined by the AIS corresponding to the frame types, for instance, but there is no limitation thereto. When the external frame is OTU-n, the AIS generator unit 63 inserts into each TTI a TTI value the frame information designates and inserts into GCC0 through GCC2 ALL “1” (binary number), for instance.

In case where the frame types of the optical signals are changed during operation, the AIS generator unit 63 may generate the notification signals N1 through Nn in accordance with the frame types that have been changed, without setting by the network management device 80, because the frame information is updated by the frame detection unit 61. Thus the embodiment saves trouble of changing setting of the frame types.

The AIS generator unit 63 outputs the notification signals N1 through Nn to the plurality of electro-optic conversion units 64, respectively.

The electro-optic conversion units 64, which are laser diodes that output optical signals variable in wavelength, for instance, convert the notification signals N1 through Nn into wavelength optical signals W1 through Wn having the same wavelengths (having the same wavelengths) as the optical signals S1 through Sn have. For instance, the notification signal N1 is converted into the wavelength optical signal W1 having the same wavelength as the optical signal S1 has, and the notification signal N2 is converted into the wavelength optical signal W2 having the same wavelength as the optical signal S2 has. In the electro-optic conversion units 64, the wavelengths are then determined by the device control unit 10. The wavelength optical signals W1 through Wn are inputted into the plurality of optical switches 71.

The optical switches 71, which are connected to the electro-optic conversion units 64, the separator unit 51, and the transponders 911, select either of two optical signals inputted from the electro-optic conversion units 64 and the separator unit 51, in accordance with control by the device control unit 10, and output the selected optical signal to the transponders 911. To the optical switches 71, more specifically, the wavelength optical signals W1 through Wn are inputted from the electro-optic conversion units 64 and the optical signals S1 through Sn are inputted from the separator unit 51. The optical switches 71 select and output to the transponders 911 either of the wavelength optical signals W1 through Wn and the optical signals S1 through Sn, in accordance with the control by the device control unit 10.

That is, the optical switches 71 switch output to the transponders 911 between the wavelength optical signals W1 through Wn and the optical signals S1 through Sn, in accordance with the control by the device control unit 10. The switching is preferably carried out so that the optical signals inputted into the transponders 911 may suffer no instantaneous failure.

When the multiplex optical signal Smx is received in the input-side amplifier 21, namely, when the reception detection unit 21a detects reception of the multiplex optical signal Smx, the device control unit 10 controls the optical switches 71 so that the optical signals S1 through Sn are outputted to the transponders 911. When the multiplex optical signal Smx is not received in the input-side amplifier 21, namely, when the reception detection unit 21a does not detect the reception of the multiplex optical signal Smx, the device control unit 10 controls the optical switches 71 so that the wavelength optical signals W1 through Wn are outputted to the transponders 911.

When the wavelength multiplex optical signal Smx is not received in the input-side amplifier 21, accordingly, the plurality of electro-optic conversion units 64 transmit the wavelength optical signals in place of the optical signals to the plurality of transponders 911. When the WDM line failure alarm is detected, therefore, the notification signals N1 through Nn that give notice of the alarm are respectively transmitted to the plurality of transponders 911.

Upon reception of the notification signals N1 through Nn, the transponders 911 in the receiving-side transmission device 91 notify the device control unit 910 of generation of the WDM line failure alarm. Then the wavelengths and the frame types of the notification signals N1 through Nn are the same as the wavelengths and the frame types of the optical signals S1 through Sn, and thus the optical signal failure alarm is not detected in the transponders 911.

Therefore, the receiving-side transmission device 91 may detect a failure in reception of the multiplex optical signal Smx in the transmission device 1 and does not output the optical signal failure alarm, that is, a false alarm that indicates a failure in reception in the receiving-side transmission device 91. In the transmission device 1 according to the embodiment, accordingly, alarm factors may easily be identified.

In the embodiment, additional communication lines for control and additional control protocol are not used between the transmission devices 1 and 91. Therefore, the embodiment is superior to the third comparative example described above in costs and possibility.

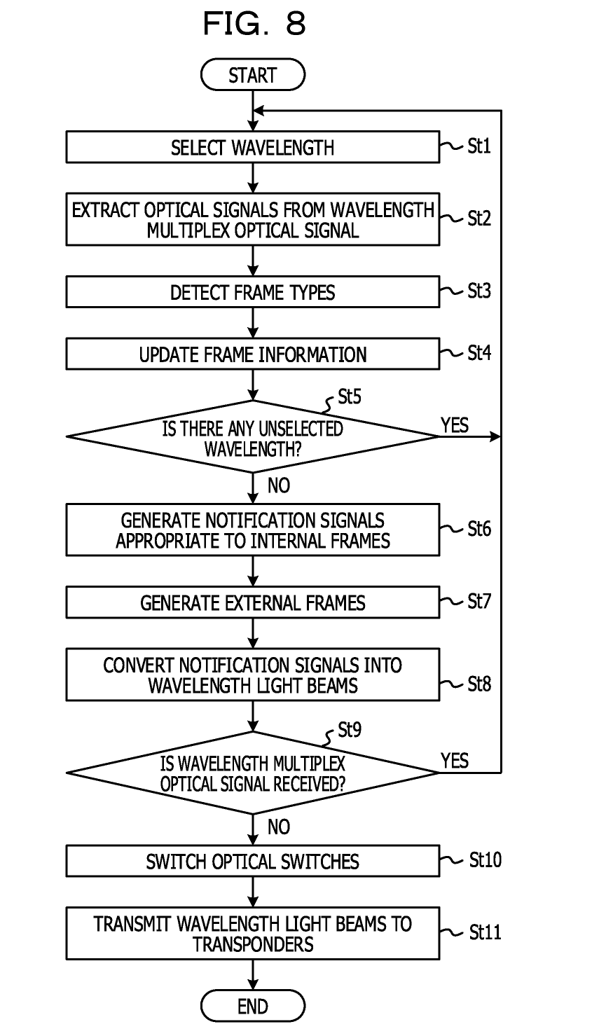

Subsequently, processing (transmission method) in the transmission device 1 will be described. FIG. 8 is a flow chart illustrating the processing in the transmission device 1 according to the first embodiment.

Initially, the wavelength extraction unit 60 selects one of the wavelengths that are to be made to demultiplex from among the wavelengths included in the multiplex optical signal Smx, based on instructions from the device control unit 10 (step St1) and extracts the optical signals 51 through Sn from the multiplex optical signal Smx (step St2). Subsequently, the frame detection unit 61 detects the frame types of the extracted optical signals 51 through Sn (step St3).

Subsequently, the frame detection unit 61 updates the frame information in the storage unit 62, based on the detected types of the external frames and the internal frames (step St4). When there is any unselected wavelength for processing of the step St1 (Yes in step St5), processing of the steps St1 through St4 is carried out again. Then an unselected wavelength is selected in the processing of the step St1. In the processing of the steps St1 through St4, in this manner, the frame types of the optical signals S1 through Sn that are to be made to demultiplex are sequentially obtained and recorded as the frame information.

When there is no unselected wavelength for the processing of the step St1 (No in step St5), the AIS generator unit 63 generates the notification signals N1 through Nn appropriate to the types of the internal frames the frame information designates (step St6). Subsequently, the AIS generator unit 63 generates the external frames that are to store the notification signals N1 through Nn in accordance with the types of the external frames the frame information designates (step St7).

Subsequently, the electro-optic conversion units 64 convert the notification signals N1 through Nn into the wavelength optical signals W1 through Wn appropriate to the optical signals S1 through Sn (step St8). Thus the notification signals N1 through Nn are converted into the optical signals having the same wavelengths as the optical signals S1 through Sn have.

Subsequently, the device control unit 10 determines by the reception detection unit 21a whether the multiplex optical signal Smx is received or not (step St9). When the multiplex optical signal Smx is received (Yes in step St9), the device control unit 10 does not set about controlling the optical switches 71 and the processing of the step St1 is carried out again.

When the multiplex optical signal Smx is not received (No in step St9), the device control unit 10 switches the optical switches 71 so that the notification signals N1 through Nn (wavelength optical signals W1 through Wn) are outputted in place of the optical signals S1 through Sn to the transponders 911 (step St10). Subsequently, the electro-optic conversion units 64 transmit the wavelength optical signals W1 through Wn through the optical switches 71 to the transponders 911 (step St11). Thus the processing in the transmission device 1 is carried out.

### Second Embodiment

Though the frame information is produced by the frame detection unit 61 and is stored in the storage unit 62 in the first embodiment, the frame information may be set by the network management device 80, without limitation thereto. In this configuration, the wavelength extraction unit 60 and the frame detection unit 61 become redundant and thus the scale of the hardware is decreased in comparison with the first embodiment.

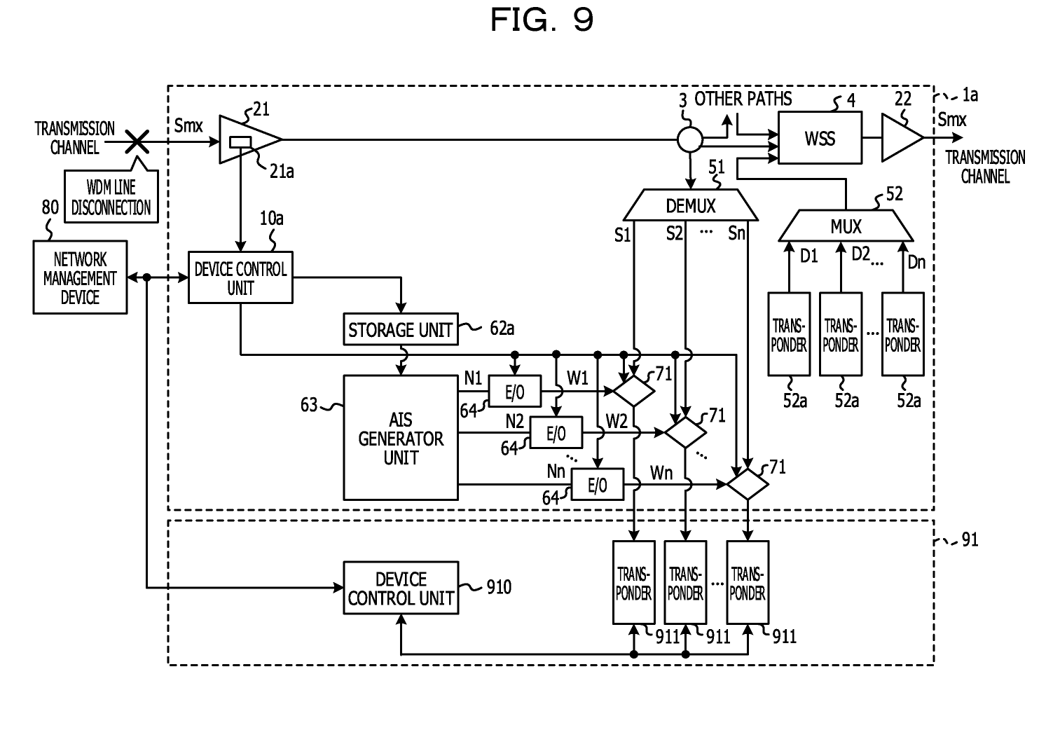

FIG. 9 is a structure chart illustrating functional configurations of transmission devices according to a second embodiment. In FIG. 9, configurations common to FIG. 4 are provided with the same reference characters, and description thereof is omitted.

A transmission device (first transmission device) is includes a device control unit (input unit) 10a, the input-side amplifier 21, the output-side amplifier 22, the optical splitter 3, the wavelength selective switch 4, the separator unit 51, the multiplexer unit 52, and the plurality of transponders 52a. The transmission device is further includes a storage unit 62a, the AIS generator unit 63, the plurality of electro-optic conversion unit 64, and the plurality of optical switches 71.

The device control unit 10a includes processors such as CPUs and the like, for instance. The device control unit 10a communicates with the network management device 80 and controls the entire transmission device la. As is the case with the device control unit 10 of the first embodiment, the device control unit 10a carries out the determination of the wavelengths for the wavelength selective switch 4, the determination of the wavelengths for the electro-optic conversion units 64, and the switching of the optical switches 71.

The device control unit 10a receives input of the frame information from the network management device 80 and stores the inputted frame information in the storage unit 62a. The storage unit 62a, which is a memory, for instance, stores the frame information. As described above, the frame information designates frame types of each of the optical signals (optical signals to be made to demultiplex) S1 through Sn that are separated from the wavelength multiplex optical signal Smx and that are transmitted to the transponders 911 (see FIG. 7).

The AIS generator unit 63 generates the notification signals N1 through Nn, in accordance with the frame types read out from the storage unit 62a. The notification signals N1 through Nn are converted into the wavelength optical signals W1 through Wn by the electro-optic conversion units 64. When the multiplex optical signal Smx is not received, the wavelength optical signals W1 through Wn are transmitted in place of the optical signals S1 through Sn through the optical switches 71 to the transponders 911.

As is the case with the first embodiment, the embodiment also curbs the generation of the optical signal failure alarm in the transponders 911. Though the frame information is inputted from the network management device 80 into the device control unit 10a in the embodiment, the frame information may be inputted from a terminal device such as a personal computer into the device control unit 10a, without limitation thereto.

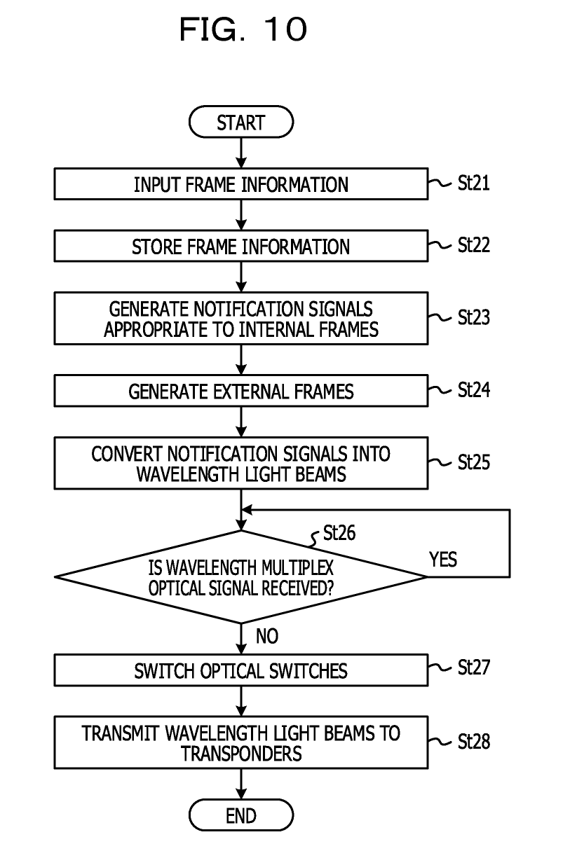

Subsequently, processing (transmission method) in the transmission device is will be described. FIG. 10 is a flow chart illustrating the processing in the transmission device is according to the second embodiment.

Initially, the frame information is inputted from the network management device 80 into the device control unit 10a (step St21). Subsequently, the device control unit 10a stores the frame information in the storage unit 62a (step St22).

Subsequently, the AIS generator unit 63 generates the notification signals N1 through Nn appropriate to the types of the internal frames the frame information designates (step St23). Subsequently, the AIS generator unit 63 generates the external frames that are to store the notification signals N1 through Nn in accordance with the types of the external frames the frame information designates (step St24). Subsequently, the electro-optic conversion units 64 convert the notification signals N1 through Nn into the wavelength optical signals W1 through Wn appropriate to the optical signals S1 through Sn (step St25).

Subsequently, the device control unit 10a determines by the reception detection unit 21a whether the multiplex optical signal Smx is received or not (step St26). When the multiplex optical signal Smx is not received (No in step St26), the device control unit 10a switches the optical switches 71 so that the notification signals N1 through Nn (wavelength optical signals W1 through Wn) are outputted in place of the optical signals S1 through Sn to the transponders 911 (step St27). When the multiplex optical signal Smx is received (Yes in step St26), the device control unit 10a does not set about controlling the optical switches 71 and carries out processing of the step St26 again.

Subsequently, the electro-optic conversion units 64 transmit the wavelength optical signals W1 through Wn through the optical switches 71 to the transponders 911 (step St28). Thus the processing in the transmission device is is carried out.

### Third Embodiment

Though the switching between the optical signals S1 through Sn and the notification signals N1 through Nn that are transmitted to the transponders 911 is carried out by the plurality of optical switches 71 in the first embodiment and the second embodiment, the switching may be carried out by a single optical switch with the wavelength multiplexing of the wavelength optical signals W1 through Wn. In this configuration, number of the optical switches is decreased in comparison with the first embodiment and the second embodiment, and cost reduction is consequently attained.

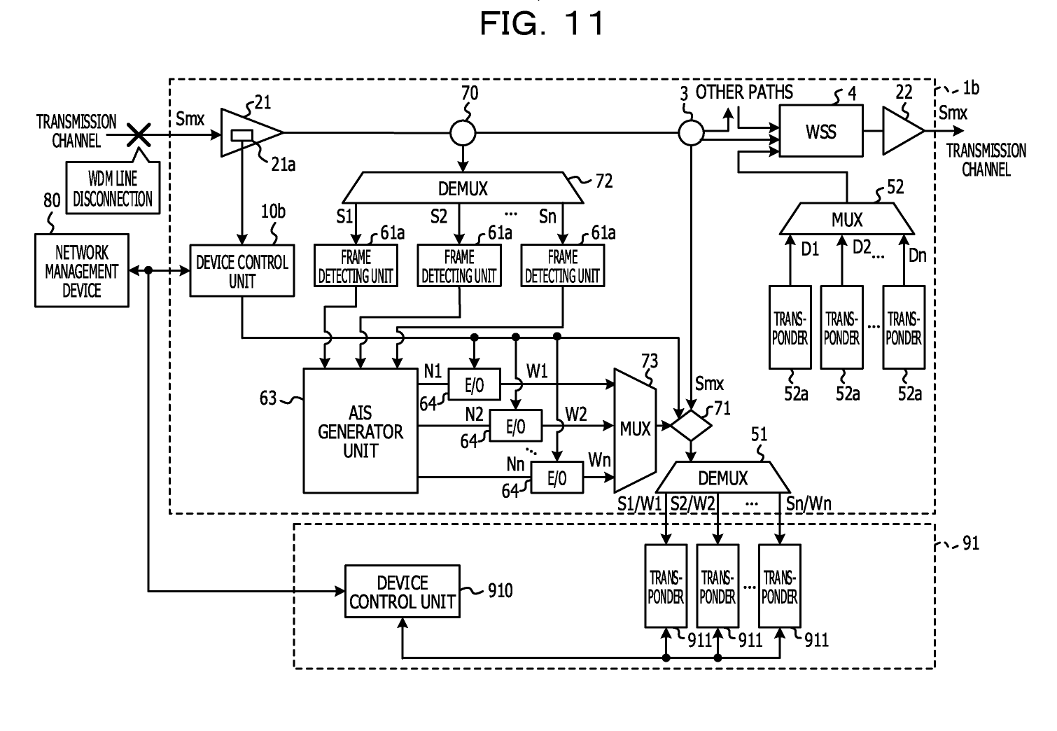

FIG. 11 is a structure chart illustrating functional configurations of transmission devices according to a third embodiment. In FIG. 11, configurations common to FIG. 4 are provided with the same reference characters, and description thereof is omitted.

A transmission device (first transmission device) 1b includes a device control unit 10b, the input-side amplifier 21, the output-side amplifier 22, the optical splitters 70 and 3, the wavelength selective switch 4, the separator (demultiplexer) unit 51, the multiplexer unit 52, and the plurality of transponders 52a. The transmission device 1b further includes a wavelength separator unit (DEMUX) 72, a plurality of frame detection units (detection units) 61a, the AIS generator unit 63, the plurality of electro-optic conversion units 64, a wavelength light multiplexer unit (multiplexer unit) (MUX) 73, and an optical switch (switching unit) 71a.

The device control unit 10b includes processors such as CPUs and the like, for instance. The device control unit 10b communicates with the network management device 80 and controls the entire transmission device 1b. As is the case with the device control unit 10 of the first embodiment, the device control unit 10b carries out the determination of the wavelengths for the wavelength selective switch 4, the determination of the wavelengths for the electro-optic conversion units 64, and switching of the optical switch 71a.

The wavelength separator unit 72, which is an AWG, for instance, demultiplexes the multiplex optical signal Smx into the optical signal S1 through Sn respectively having wavelengths that are to be made to demultiplex. The optical signals 51 through Sn are respectively inputted into the plurality of frame detection units 61a.

The frame detection units 61a detect the frame types of the optical signal S1 through Sn as the frame detection unit 61 of the first embodiment does. The frame detection units 61a produce frame information, based on results of the detection and output the frame information to the AIS generator unit 63. The frame information is produced by the plurality of frame detection units 61a and is thus outputted as separate pieces of information corresponding to the optical signals 51 through Sn.

The AIS generator unit 63 generates the notification signals N1 through Nn, based on the frame information inputted from the plurality of frame detection units 61a. The notification signals N1 through Nn are converted by the electro-optic conversion units 64 into the wavelength optical signals W1 through Wn, which are inputted into the wavelength light multiplexer unit 73.

The wavelength light multiplexer unit 73 multiplexes the wavelength optical signals W1 through Wn inputted from the plurality of electro-optic conversion units 64 and thereby produces multiplexed optical signal Wmx. The multiplexed optical signal Wmx is inputted into the optical switch 71a.

The optical switch 71a, which is connected to the optical splitter 3, the wavelength light multiplexer unit 73, and the separator unit 51, selects either of two optical signals inputted from the optical splitter 3 and the wavelength light multiplexer unit 73, in accordance with control by the device control unit 10b, and outputs the selected optical signal to the separator unit 51. To the optical switch 71a, more specifically, the multiplexed optical signal Wmx is inputted from the wavelength light multiplexer unit 73 and the multiplex optical signal Smx is inputted from the optical splitter 3. The optical switch 71a selects either of the multiplexed optical signal Wmx and the multiplex optical signal Smx, in accordance with the control by the device control unit 10b, and outputs the selected optical signal or signal to the separator unit 51.

That is, the optical switch 71a switches output to the separator unit 51 between the multiplexed optical signal Wmx and the multiplex optical signal Smx, in accordance with the control by the device control unit 10b. Thus the separator unit 51 respectively guides to the plurality of transponders 911 either of the wavelength optical signals W1 through Wn obtained by demultiplexing of the multiplexed optical signal Wmx and the optical signals S1 through Sn obtained by demultiplexing of the multiplex optical signal Smx. The switching is preferably carried out so that the optical signal inputted into the transponders 911 may suffer no instantaneous failure.

When the multiplex optical signal Smx is received in the input-side amplifier 21, namely, when the reception detection unit 21a detects reception of the multiplex optical signal Smx, the device control unit 10b controls the optical switch 71a so that the multiplex optical signal Smx is outputted to the separator unit 51. When the multiplex optical signal Smx is not received in the input-side amplifier 21, namely, when the reception detection unit 21a does not detect the reception of the multiplex optical signal Smx, the device control unit 10b controls the optical switch 71a so that the multiplexed optical signal Wmx is outputted to the separator unit 51.

When the multiplex optical signal Smx is not received in the input-side amplifier 21, accordingly, the optical switch 71a switches an optical signal that is inputted into the separator unit 51, which demultiplexes the inputted optical signal in accordance with wavelengths, from the multiplex optical signal Smx to the multiplexed optical signal Wmx. Thus the multiplexed optical signal Wmx is separated by the separator unit 51 into the wavelength optical signals W1 through Wn, which are thereafter guided to the receiving-side transmission device 91. That is, the plurality of electro-optic conversion units 64 transmit the wavelength optical signals W1 through Wn to the plurality of transponders 911 through the wavelength light multiplexer unit 73, the optical switch 71a, and the separator unit 51. In the receiving-side transmission device 91, the wavelength optical signals W1 through Wn are respectively inputted into the plurality of transponder 911.

As is the case with the first embodiment, the embodiment also curbs the generation of the optical signal failure alarm in the transponders 911. In the embodiment, number (1) of the optical switch 71a is smaller than that in the first embodiment and the second embodiment, and cost reduction is consequently attained. Though the frame types are detected by the plurality of frame detection units 61a in the embodiment, the frame types may be detected by the one frame detection unit 61 as is done in the first embodiment, without limitation thereto.

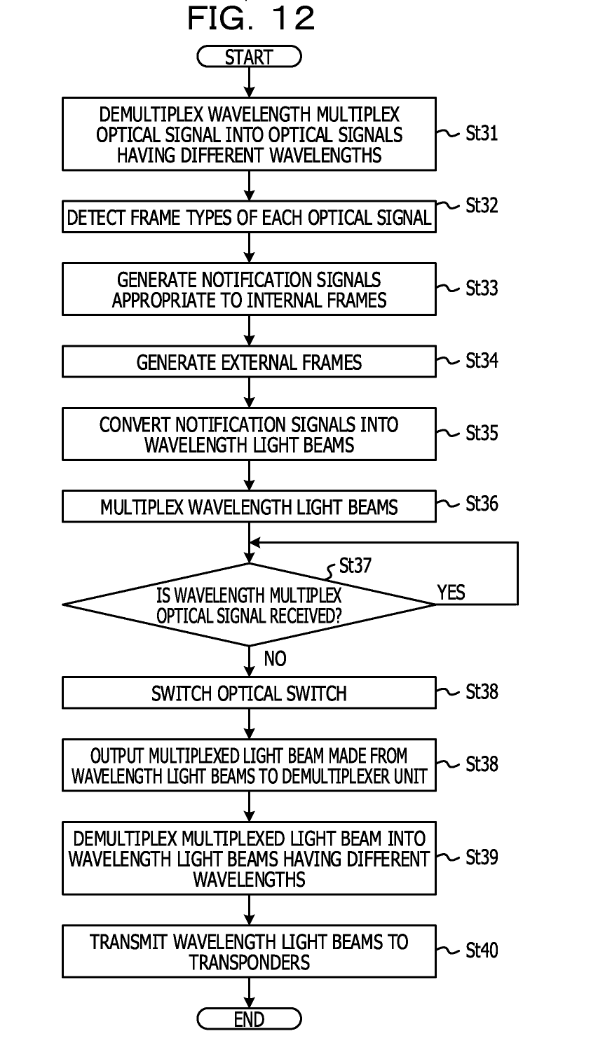

Subsequently, processing (transmission method) in the transmission device 1b will be described. FIG. 12 is a flow chart illustrating the processing in the transmission device 1b according to the third embodiment.

Initially, the wavelength separator unit 72 demultiplexes the multiplex optical signal Smx into the optical signals S1 through Sn having the different wavelengths (step St31). Subsequently, the plurality of frame detection units 61a respectively detect the frame types of the optical signal S1 through Sn (step St32). The AIS generator unit 63 is notified of results of the detection as the separate pieces of the frame information corresponding to the optical signals S1 through Sn.

Subsequently, the AIS generator unit 63 generates the notification signals N1 through Nn appropriate to the types of the internal frames the frame information designates (step St33). Subsequently, the AIS generator unit 63 generates the external frames that are to store the notification signals N1 through Nn in accordance with the types of the external frames the frame information designates (step St34).

Subsequently, the electro-optic conversion units 64 convert the notification signals N1 through Nn into the wavelength optical signals W1 through Wn appropriate to the optical signals S1 through Sn (step St35). Subsequently, the wavelength light multiplexer unit 73 multiplexes the wavelength optical signals W1 through Wn and thereby produces the multiplexed optical signal Wmx (step St36).

Subsequently, the device control unit 10b determines by the reception detection unit 21a whether the multiplex optical signal Smx is received or not (step St37). When the multiplex optical signal Smx is not received (No in step St37), the device control unit 10b switches the optical switch 71a so that the multiplexed optical signal Wmx is outputted in place of the multiplex optical signal Smx to the separator unit 51 (step St38). When the multiplex optical signal Smx is received (Yes in step St37), the device control unit 10b does not set about controlling the optical switch 71a and processing of the step St37 is carried out again.

Subsequently, the multiplexed optical signal Wmx is outputted from the wavelength light multiplexer unit 73 to the separator unit 51 (step St39). Subsequently, the separator unit 51 demultiplexes the multiplexed optical signal Wmx into the wavelength optical signals W1 through Wn having the different wavelengths (step St40). Subsequently, the wavelength optical signals W1 through Wn are respectively transmitted to the plurality of transponder 911 (step St41). Thus the processing in the transmission device 1b is carried out.

As described above, the transmission devices 1, 1a, and 1b according to the embodiments include the receiver unit (input-side amplifier) 21, the generator unit (AIS generator unit) 63, and the one or more transmitter units (electro-optic conversion units) 64. The receiver unit 21 receives the wavelength multiplex optical signal Smx in which the plurality of optical signals different in terms of wavelength are multiplexed.

The generator unit 63 generates the notification signals N1 through Nn that notify another device (receiving-side transmission device) 91 of a failure in the reception of the wavelength multiplex optical signal, for the optical signals S1 through Sn that are separated from the wavelength multiplex optical signal and that are transmitted to another device 91, out of the plurality of optical signals, in accordance with the frame types of the pertinent optical signals. The one or more transmitter units 64 respectively convert the notification signals N1 through Nn into the wavelength optical signals W1 through Wn having the same wavelengths as the pertinent optical signals out of the plurality of optical signals have. When the wavelength multiplex optical signal Smx is not received in the receiver unit 21, the one or more transmitter units 64 transmit the wavelength optical signals W1 through Wn in place of the pertinent optical signals to another device 91.

In the transmission devices 1, 1a, and 1b according to the embodiments, the notification signals N1 through Nn that give notice of a failure in the reception of the wavelength multiplex optical signal Smx are generated by the generator unit 63, in accordance with the frame types of the optical signals S1 through Sn that are separated from the wavelength multiplex optical signal Smx and that are transmitted to another device 91. The notification signals N1 through Nn are converted by the transmitter units 64 into the wavelength optical signals W1 through Wn having the same wavelengths as the optical signals have. When the wavelength multiplex optical signal Smx is not received in the receiver unit 21, the wavelength optical signals W1 through Wn are transmitted in place of the optical signals to another device 91.

When the wavelength multiplex optical signal Smx is not received, accordingly, another device 91 that is to receive the optical signals S1 through Sn receives the wavelength optical signals W1 through Wn (notification signals N1 through Nn) that have the same wavelengths and the same frames as the optical signals S1 through Sn have, in place of the optical signals S1 through Sn. Therefore, another device 91 may detect a failure in the reception of the wavelength multiplex optical signal Smx in the transmission device 1, 1a, 1b and does not output a false alarm that designates a failure in the reception in another device. In the transmission devices 1, 1a, and 1b according to the embodiments, accordingly, alarm factors may easily be identified.

Transmission systems according to the embodiments include the first transmission device (transmission device) 1, 1a, 1b and the second transmission device (receiving-side transmission device) 91 that are connected to each other through the transmission channels. The first transmission device 1, 1a, 1b includes the receiver unit (input-side amplifier) 21, the generator unit (AIS generator unit) 63, and the one or more transmitter units (electro-optic conversion units) 64.

The receiver unit 21 receives the wavelength multiplex optical signal Smx in which the plurality of optical signals different in terms of wavelength are multiplexed. The generator unit 63 generates the notification signals N1 through Nn that notify the second transmission device 91 of a failure in the reception of the wavelength multiplex optical signal, for the optical signals S1 through Sn that are separated from the wavelength multiplex optical signal and that are transmitted to the second transmission device 91, out of the plurality of optical signals, in accordance with the frame types of the pertinent optical signals. The one or more transmitter units 64 respectively convert the notification signals N1 through Nn into the wavelength optical signals W1 through Wn having the same wavelengths as the pertinent optical signals out of the plurality of optical signals have. When the wavelength multiplex optical signal Smx is not received in the receiver unit 21, the one or more transmitter units 64 transmit the wavelength optical signals W1 through Wn in place of the pertinent optical signals to the second transmission device 91.

The second transmission device 91 receives the wavelength optical signals W1 through Wn transmitted from the one or more transmitter units 64.

The transmission systems according to the embodiments include the transmission device 1, 1a, 1b and therefore provide functional effects similar to those described above.

A transmission method according to the embodiments includes steps below. Step (1): The notification signals N1 through Nn that notify the transmission device (receiving-side transmission device) 91 of a failure in the reception of the wavelength multiplex optical signal Smx in which the plurality of optical signals different in terms of wavelength are multiplexed are generated for the optical signals S1 through Sn that are separated from the wavelength multiplex optical signal Smx and that are transmitted to the transmission device 91, out of the plurality of optical signals, in accordance with the frame types of the pertinent optical signals. Step (2): The notification signals N1 through Nn are converted into the wavelength optical signals W1 through Wn having the same wavelengths as the pertinent optical signals out of the plurality of optical signals have. When the wavelength multiplex optical signal Smx is not received, the wavelength optical signals W1 through Wn are transmitted in place of the pertinent optical signals to the transmission device 91.

The transmission method according to the embodiments includes a configuration similar to the transmission device 1, 1a, 1b and therefore provides functional effects similar to those described above.

Though the preferred embodiments have been referred to and have been described above specifically, it is obvious that persons skilled in the art may adopt various modifications based on fundamental technological thoughts and teachings herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a receiver which receives a wavelength multiplex optical signal having a plurality of optical signals different in terms of wavelength multiplexed;
a generator which generates notification signals, which notify another device of a failure in reception of the wavelength multiplex optical signal, for optical signals which are separated from the wavelength multiplex optical signal and which are transmitted to the other device, out of the plurality of optical signals, in accordance with frame types of the optical signals; and
one or more transmitters which respectively convert the notification signals into wavelength optical signals having the same wavelengths as the optical signals out of the plurality of optical signals have and which respectively transmit the wavelength optical signals in place of the optical signals to the other device when the wavelength multiplex optical signal is not received in the receiver.

2. The transmission device according to claim 1, further comprising:
a detector which detects the frame types of each of the optical signals that are separated from the wavelength multiplex optical signal and that are transmitted to the other device, out of the plurality of optical signals,
wherein the generator generates the notification signals in accordance with the frame types the detector detects.

3. The transmission device according to claim 1, further comprising:
an input device into which frame information that represents the frame types of each of the optical signals that are separated from the wavelength multiplex optical signal and that are transmitted to the other device out of the plurality of optical signals is inputted; and
a storage which stores the frame information,
wherein the generator generates the notification signals in accordance with the frame types read out from the storage.

4. The transmission device according to claim 1, further comprising:
a multiplexer which multiplexes the wavelength optical signals inputted from the one or more transmitters and which produces a multiplexed optical signal;
a demultiplexer which demultiplexes an inputted optical signal in accordance with wavelengths and which guides the demultiplexed optical signals to the other device; and
a switch which switches the optical signal that is to be inputted into the demultiplexer from the wavelength multiplex optical signal to the multiplexed optical signal when the wavelength multiplex optical signal is not received in the receiver,
wherein the one or more transmitters transmit the wavelength optical signals to the other device through the multiplexer, the switch, and the demultiplexer.

5. A transmission system including a first transmission device and a second transmission device that are connected to each other through transmission channels,
wherein the first transmission device includes
a receiver which receives a wavelength multiplex optical signal in which a plurality of optical signals different in terms of wavelength are multiplexed;
a generator which generates notification signals, which notify the second transmission device of a failure in reception of the wavelength multiplex optical signal, for optical signals that are separated from the wavelength multiplex optical signal and that are transmitted to the second transmission device, out of the plurality of optical signals, in accordance with frame types of the optical signals; and
one or more transmitters which respectively convert the notification signals into wavelength optical signals having the same wavelengths as the optical signals out of the plurality of optical signals have and which respectively transmit the wavelength optical signals in place of the optical signals to the second transmission device when the wavelength multiplex optical signal is not received in the receiver,
wherein the second transmission device receives the wavelength optical signals transmitted from the one or more transmitters.

6. The transmission system according to claim 5,
wherein the first transmission device further includes a detector which detects the frame types of each of the optical signals that are separated from the wavelength multiplex optical signal and that are transmitted to the second transmission device, out of the plurality of optical signals, and
wherein the generator generates the notification signals in accordance with the frame types the detector detects.

7. The transmission system according to claim 5,
wherein the first transmission device further includes
an input device into which frame information that represents the frame type of each of the optical signals that are separated from the wavelength multiplex optical signal and that are transmitted to the second transmission device out of the plurality of optical signals is inputted; and
a storage which stores the frame information, and
wherein the generator generates the notification signals in accordance with the frame types read out from the storage.

8. The transmission system according to claim 5, further comprising:
a multiplexer which multiplexes the wavelength optical signals inputted from the one or more transmitters and which produces a multiplexed optical signal;
a demultiplexer which demultiplexes an inputted optical signal in accordance with wavelengths and which guides the demultiplexed optical signals to the second transmission device; and
a switch which switches the optical signal that is to be inputted into the demultiplexer from the wavelength multiplex optical signal to the multiplexed optical signal when the wavelength multiplex optical signal is not received in the receiver,
wherein the one or more transmitters transmit the wavelength optical signals to the second transmission device through the multiplexer, the switch, and the demultiplexer.

9. A transmission method comprising:
generating notification signals, which notify a transmission device of a failure in reception of a wavelength multiplex optical signal in which a plurality of optical signals different in terms of wavelength are multiplexed, for optical signals that are separated from the wavelength multiplex optical signal and that are transmitted to the transmission device, out of the plurality of optical signals, in accordance with frame types of the optical signals; and
converting the notification signals into wavelength optical signals having the same wavelengths as the optical signals out of the plurality of optical signals have, and transmitting the wavelength optical signals in place of the optical signals to the transmission device when the wavelength multiplex optical signal is not received.

10. The transmission method according to claim 9, further comprising:
detecting the frame types of each of the optical signals that are separated from the wavelength multiplex optical signal and that are transmitted to the transmission device, out of the plurality of optical signals; and
generating the notification signals in accordance with the detected frame types.

11. The transmission method according to claim 9, further comprising:
inputting frame information that represents the frame types of each of the optical signals that are separated from the wavelength multiplex optical signal and that are transmitted to the transmission device, out of the plurality of optical signals;
storing the frame information in a storage; and
generating the notification signals in accordance with the frame types read out from the storage.

12. The transmission method according to claim 9, further comprising:
multiplexing the wavelength optical signals and producing a multiplexed optical signal;
switching an optical signal that is to be inputted into a demultiplexer configured to demultiplex an optical signal, from the wavelength multiplex optical signal to the multiplexed optical signal when the wavelength multiplex optical signal is not received; and
demultiplexing the multiplexed optical signal in accordance with wavelengths and guiding the demultiplexed optical signals to the transmission device by the demultiplexer.
